(19) United States
(12) Patent Application Publication
(10) Pub. No.: US 2015/0242784 A1
(43) Pub. Date: Aug. 27, 2015

(54) ORDER QUANTITY DETERMINING METHOD, ORDER QUANTITY DETERMINING APPARATUS, AND RECORDING MEDIUM

(71) Applicant: FUJITSU LIMITED, Kawasaki-shi (JP)

(72) Inventors: Yoshinobu MATSUI, Kawasaki (JP); Yuhei Umeda, Kawasaki (JP); Kazuhiro Matsumoto, Kawasaki (JP); Hirokazu Anai, Hachioji (JP); Isamu Watanabe, Kawasaki (JP)

(21) Appl. No.: 14/618,698

(22) Filed: Feb. 10, 2015

(30) Foreign Application Priority Data
Feb. 24, 2014 (JP) 2014-033457

(51) Int. Cl. G06Q 10/06

(52) U.S. Cl. CPC G06Q 10/06315

(57) ABSTRACT

An order quantity determining method includes: receiving restriction information used for calculating a profit based on an order quantity of a product; specifying a combination of order quantities of a k-th period to a (k+H)-th period for which the profit is the highest by using the restriction information, by a processor; and outputting the order quantity of the k-th period based on the specified combination.

### CROSS-REFERENCE TO RELATED APPLICATION

This application is based upon and claims the benefit of priority of the prior Japanese Patent Application No. 2014-033457, filed on Feb. 24, 2014, the entire contents of which are incorporated herein by reference.

### FIELD

The embodiments discussed herein are related to an order quantity determining method, an order quantity determining apparatus, and an order quantity determining program.

### BACKGROUND

There are technologies for managing a stock quantity of a warehouse by predicting a demand for a product and determining a secure order quantity level not causing out-of-stock based on a difference from a prediction error. The prediction error is the number of products that are sold over a prediction of the demand for the products. In such technologies, an order quantity of a product is determined by adding the prediction error to a predicted demand of the product. In this way, by ordering products more than the predicted demand, it is prevented to lose an opportunity for selling the products due to out-of-stock in a case where an actual demand increases to be larger than the predicted demand.

Japanese Laid-open Patent Publication No. 2007-200185

### SUMMARY

According to an aspect of the embodiments, an order quantity determining method includes: receiving restriction information used for calculating a profit based on an order quantity of a product; specifying a combination of order quantities of a k-th period to a (k+H)-th period for which the profit is the highest by using the restriction information, by a processor; and outputting the order quantity of the k-th period based on the specified combination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram that illustrates the configuration of an order quantity determining apparatus according to a first embodiment;

FIG. 2 is a diagram that illustrates an example of the data structure of sales data;

FIG. 3 is a diagram that illustrates an example of the data structure of a setting information table;

FIG. 4 is a diagram that illustrates an example of the data structure of a predicted demand table;

FIG. 5 is a diagram that illustrates an example of an order quantity determining system;

FIG. 6 is a diagram that illustrates a lead time that is a time until a product arrives at a warehouse after the product is ordered;

FIG. 7 is a diagram that illustrates a first example of a GUI image;

FIG. 8 is a flowchart that illustrates an example of the flow of the entire process of acquiring optimal order quantities;

FIG. 9 is a diagram that illustrates a first example of a predicted demand;

FIG. 10 is a diagram that illustrates a first example of an optimal order quantity;

FIG. 11 is a diagram that illustrates a first example of a predicted profit;

FIG. 12 is a diagram that illustrates a second example of the predicted demand;

FIG. 13 is a diagram that illustrates a second example of the optimal order quantity;

FIG. 14 is a diagram that illustrates a second example of the predicted profit;

FIG. 15 is a functional block diagram that illustrates the configuration of an order quantity determining apparatus according to a second embodiment;

FIG. 16 is a diagram that illustrates a second example of the GUI image; and

FIG. 17 is a diagram that illustrates the hardware configuration of the order quantity determining apparatus according to the first or second embodiment.

### DESCRIPTION OF EMBODIMENTS

However, there is a problem in that a profit is not increased under a restriction.

There are cases where the profit does not increase even in a case where out-of-stock is avoided by adding a prediction error to a predicted demand. For example, when an order quantity of a product is increased to be more than the demand so as not to cause out-of-stock, a cost for storing products by holding the superfluous stock in a warehouse increases, and there are cases where the profit decreases. Meanwhile, there are various restrictions on inventory control of products. For example, since there is a limit in the order quantity for a production source, even when an order quantity is increased after an increase in the demand for the product, the supply of the products is not on time, and there are cases where an opportunity for selling the products is lost, and the profit decreases.

Preferred embodiments will be explained with reference to accompanying drawings. However, the scope of rights is not limited thereto. The embodiments may be appropriately combined in a range in which contents of processes are not contradictory.

### [a] First Embodiment

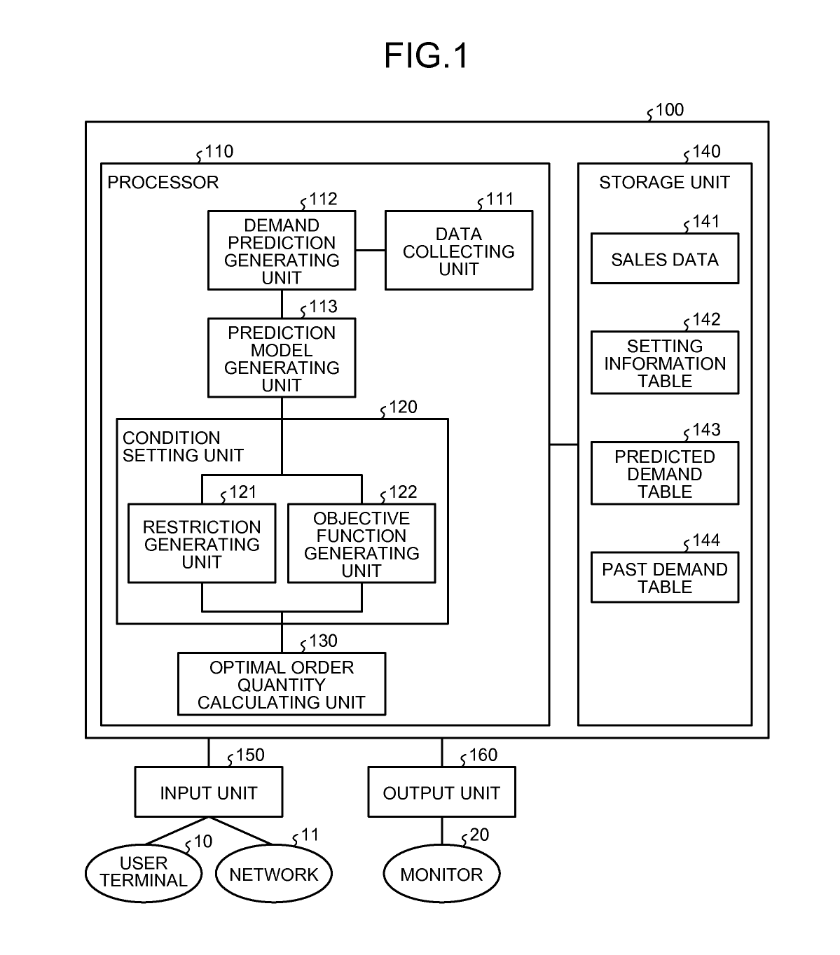

An example of the whole configuration of an order quantity determining apparatus 100 according to a first embodiment will be described. FIG. 1 is a functional block diagram that illustrates the configuration of the order quantity determining apparatus according to the first embodiment. As illustrated in the example represented in FIG. 1, the order quantity determining apparatus 100 includes a processor 110 and a storage unit 140.

Storage Unit

The storage unit 140 includes sales data 141, a setting information table 142, a predicted demand table 143, and a past demand table 144. The storage unit 140 corresponds to a storage device that includes a semiconductor memory device such as a random access memory (RAM), a read only memory (ROM), or a flash memory, a hard disk, and an optical disc.

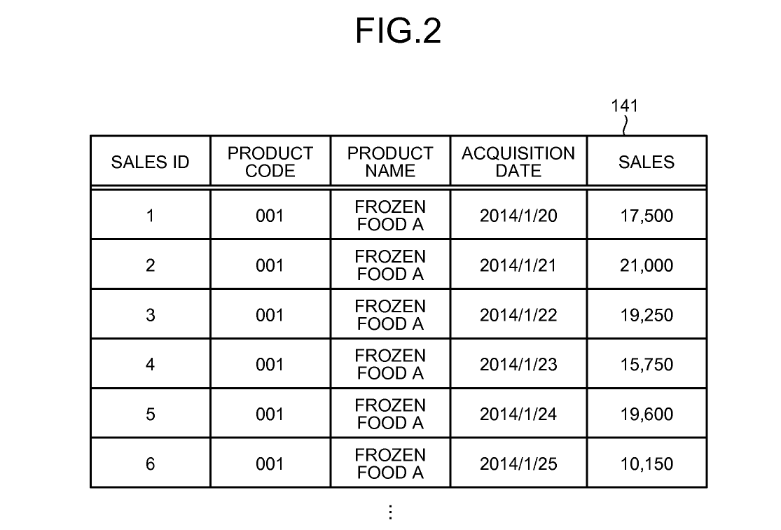

FIG. 2 is a diagram that illustrates an example of the data structure of the sales data. The sales data 141 stores sales information of each product for each period. For example, the sales data 141 is input from an external point of sale (POS) system. As illustrated in the example represented in FIG. 2, the sales data 141 associates a sales ID, a product code, a product name, acquisition date, and sales with each other. The “sales ID” is an identification number used for identifying sales of a product for each period. The “product code” is a code that is uniquely assigned to each product. The “product name” is the name of a product corresponding to a product code. The “acquisition date” is date when sales information is acquired. In the first embodiment, each date is set as the period. The “sales” is a total value of prices of sold products. As illustrated in the example represented in FIG. 2, the sales data 141 associates sales of each date with a sales ID, a product code, a product name, and acquisition date with each date being set as the period.

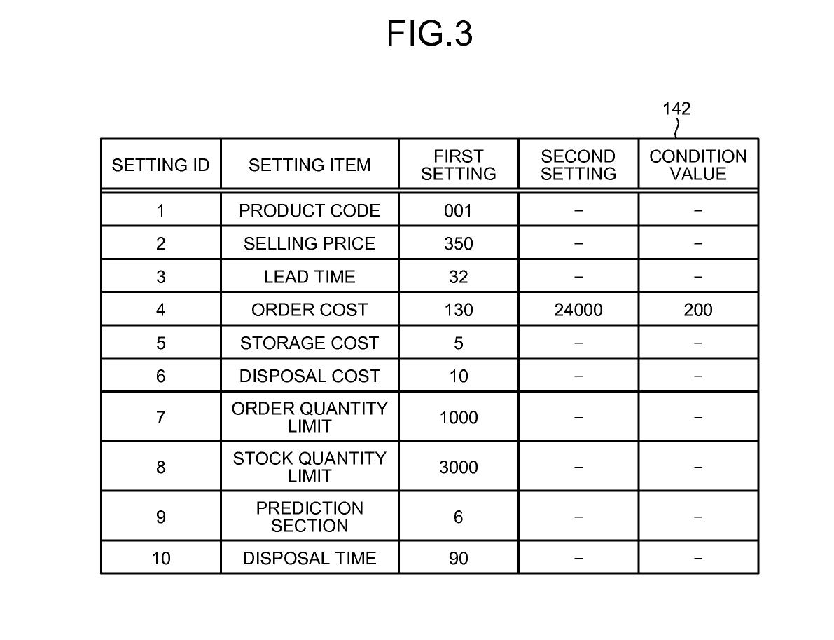

FIG. 3 is a diagram that illustrates an example of the data structure of the setting information table. The setting information table 142 stores various kinds of setting information that is input from a user terminal 10. As illustrated in the example represented in FIG. 3, the setting information table 142 associates a setting ID, a setting item, a first setting, a second setting, and a condition value with each other. The “setting ID” is an identification number that is uniquely assigned to each setting information. The “setting item” is an item name that is set for the product. The “first setting” is a first setting value for each item. The “second setting” is a second setting value for each item. The “condition value” is a value being a condition for switching between the first setting and the second setting. In a case where the “setting item” includes only one setting value, a setting value is input only to the first setting, and “—” is stored in the “second setting” and the “condition value”.

Next, each setting item of the setting information table 142 will be described with reference to FIG. 3. Product Code of a setting ID of “1” is a code that is uniquely assigned to each product and corresponds to the product code of the sales data 141. In addition, Selling Price of a setting ID of “2” is a price at the time of selling a product. For example, as illustrated in the example represented in FIG. 3, the setting information table 142 represents that the selling price per product is 350 Japanese Yen (hereinafter, referred to as Yen). Lead Time of a setting ID of “3” is a time until a product arrives at the warehouse after the product is ordered from a production source. The lead time is different depending on the kind of the product, the supplier, and the like. For example, as illustrated in the example represented in FIG. 3, the setting information table 142 represents that the lead time is 32 hours.

Order Cost of a setting ID of “4” is a cost that is consumed in a case where one product is ordered. In the order cost, in addition to a purchase price per product, a shipping cost, a commission, and the like are included. There are cases where the order cost per product is lower in a case where products are purchased in units of a set than in a case where the products are individually purchased. In such cases, the setting information table 142 may be configured to include an order cost per product in the first setting of the setting ID of “4”, include an order cost per set in the second setting, and include the number of products included in one set in the condition value. For example, as illustrated in the example represented in FIG. 3, the setting information table 142 represents that an order cost per product is 130 Yen, and an order cost per one set is 24,000 Yen. In addition, the setting information table 142 represents that the number of products included in one set is 200.

Storage Cost of a setting ID of “5” is a cost for storing one product for one period. The storage cost increases in proportion to a storage period of the product. For example, as illustrated in the example represented in FIG. 3, the setting information table 142 represents that the storage cost of a case where one product is stored for one period is five Yen. Disposal Cost of a setting ID of “6” is a cost occurring in a case where one product is discarded. For example, as illustrated in the example represented in FIG. 3, the setting information table 142 represents that a disposal cost per product is ten Yen. In addition, Order Quantity Limit of a setting ID of “7” is a maximal number of products that can be ordered from a production source once. For example, as illustrated in the example represented in FIG. 3, the setting information table 142 represents that an order quantity limit is 1,000 products that are included in one order. Stock Quantity Limit of a setting ID of “8” is a maximal number of products that can be housed inside a warehouse. For example, as illustrated in the example represented in FIG. 3, the setting information table 142 represents that the stock quantity limit is 3,000 products. Prediction Section H of a setting ID of “9” is a period during which the demand of the product is predicted. For example, as illustrated in the example represented in FIG. 3, the setting information table 142 represents that the prediction section is six months. Disposal Time of a setting ID of “10” is a time until a product is discarded after the order of the product. For example, as illustrated in the example represented in FIG. 3, the setting information table 142 represents that the product is discarded when 90 hours elapses after the product is ordered.

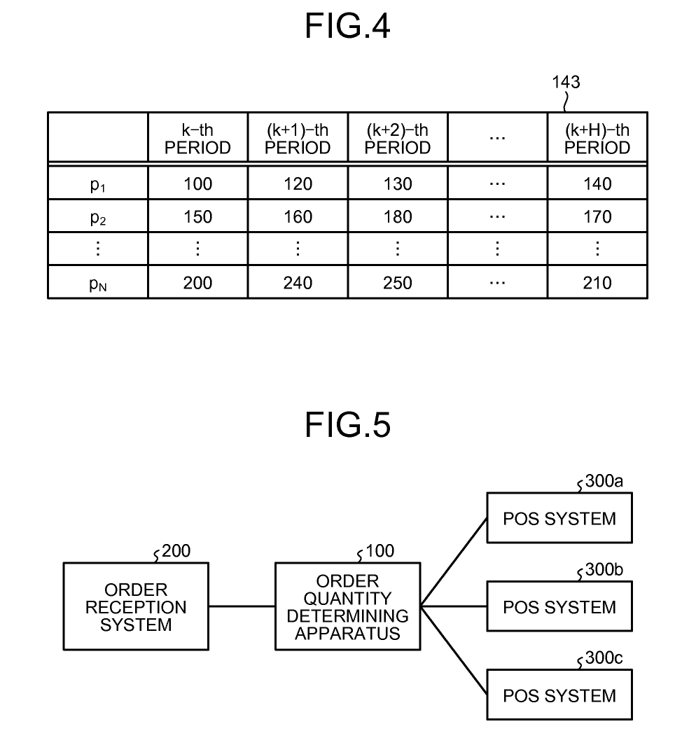

FIG. 4 is a diagram that illustrates an example of the data structure of a predicted demand table. The predicted demand table 143 is a table in which a predicted demand is associated with each prediction method. For example, the predicted demand table 143 is generated by a demand prediction generating unit 112 to be described later. As illustrated in the example represented in FIG. 4, the predicted demand table 143 stores predicted demands of a k-th period to (k+H)-th period corresponding to each of N demand prediction methods p₁ to p_{N}. For example, the predicted demand table 143 represents that a demand of the k-th period of a prediction method p₁ is 100, a demand of a (k+1)-th period is 120, a demand of a (k+2)-th period is 130, and a demand of the (k+H)-th period is 140.

The past demand table 144 stores data relating to past demands of a first period to a (k−1)-th period. The past demand table 144 may store actual demands collected by a data collecting unit 111 as is appropriate.

### (Input Unit)

The order quantity determining apparatus 100 is connected to an input unit 150 and an output unit 160. The input unit 150, for example, is a processor that receives an input of sales information from an external POS system or receives an input of setting information from the user terminal 10. The input unit 150 receives an input of setting information such as a selling price, a lead time, an order cost, a storage cost, a disposal cost, an order quantity limit, a stock quantity limit, a prediction section, and a disposal time of a product from the user terminal 10. The input unit 150 outputs each data that has been received to the setting information table 142.

In addition, the input unit 150 receives sales information from the external POS system through a network 11. The input unit 150 outputs the received sales information to the sales data 141 of the storage unit 140.

Here, communication between the order quantity determining apparatus 100 and the other systems will be described with reference to FIG. 5. FIG. 5 is a diagram that illustrates an example of an order quantity determining system. As illustrated in the example represented in FIG. 5, the order quantity determining apparatus 100 is communicably connected to an order reception system 200 and POS systems 300a, 300b, and 300c. Each of the POS systems 300a, 300b, and 300c transmits sales data of each period to the order quantity determining apparatus 100. The order quantity determining apparatus 100 calculates an optimal order quantity of a product based on the received sales data. The order quantity determining apparatus 100 appropriately transmits order information of the product to the order reception system 200 in response to a user's instruction. After receiving the order information, the order reception system 200 transmits an order reception confirmation to the order quantity determining apparatus 100.

Processor

The processor 110 includes a data collecting unit 111, a demand prediction generating unit 112, a prediction model generating unit 113, a condition setting unit 120, and an optimal order quantity calculating unit 130. The condition setting unit 120 includes a restriction generating unit 121 and an objective function generating unit 122.

For example, each configuration of the processor 110 may be realized by a central processing unit (CPU) executing a predetermined program. In addition, the functions of the processor 110, for example, may be realized by an integrated circuit such as an application specific integrated circuit (ASIC) or a field programmable gate array (FPGA).

The processor 110 receives restriction information that is used for calculating a profit based on the order quantity of a product through the input unit 150. The optimal order quantity calculating unit 130 searches for order quantities of the k-th period to the (k+H)-th period so as to increase the profit by using the restriction information. The processor 110 performs a process of outputting the order quantity of the k-th period among the retrieved order quantities through the output unit 160. For example, the input unit 150 receives one or more out of an order cost, a storage cost, and the date of delivery. The optimal order quantity calculating unit 130 solves an optimization problem having a profit of the k-th period to the (k+H) period as an objective function in consideration of one or more out of the order cost, the storage cost, and the date of delivery, thereby acquiring an order quantity of the k-th period. For example, the optimal order quantity calculating unit 130 predicts a demand of the k-th period to the (k+H)-th period and solves an optimization problem having a profit of the k-th period to the (k+H)-th period as an objective function in consideration of the predicted demand, thereby acquiring an order quantity of the k-th period. For example, the optimal order quantity calculating unit 130 predicts a demand of the k-th period to the (k+H)-th period by using a plurality of techniques for each of the techniques and solves an optimization problem having a profit of the k-th period to the (k+H)-th period as an objective function so as to increase a profit that can be secured to the minimum, thereby acquiring an order quantity of the k-th period. In addition, the output unit 160 outputs a profit prediction together with the order quantity. Here, the input unit 150 is an example of a reception unit. In addition, the optimal order quantity calculating unit 130 is an example of a search unit. Hereinafter, each configuration of the processor 110 will be described in detail.

The data collecting unit 111 is a processor that collects actual sales data from an external POS system. The data collecting unit 111 collects sales information acquired from the sales data 141 and acquires an actual demand Dᵣ[k−1] of the product. Here, Dᵣ[k−1] is the number of sold products for a (k−1)-th period that is one period before the current k-th period. The data collecting unit 111 outputs the actual demand Dᵣ[k−1] of the product to the storage unit 140. In this way, the data collecting unit 111 outputs the actual demand Dᵣ of the product to the past demand table 144 when the period elapses. In addition, the past demand table 144 stores past demands Dᵣ[1] to Dᵣ[k−1] of the product of the first period to the (k−1)-th period.

The demand prediction generating unit 112 is a processor that predicts demands of the k-th period to the (k+H)-th period that is the end of the prediction section H. The demand prediction generating unit 112 calculates respective predicted demands Dₚᵢ[k] to Dₚᵢ[k+H] (here, i=1, . . . , N) of the k-th period to the (k+H)-th period by using N prediction methods p₁ to p_{N} of demands based on the demands Dᵣ[1] to Dᵣ[k−1] included in the past demand table 144. Then, the demand prediction generating unit 112 outputs the predicted demands Dₚᵢ[k] to Dₚᵢ[k+H] to the predicted demand table 143.

Here, in the prediction methods p₁ to p_{N} of demands, estimating the demands to be higher than those acquired by using the other prediction methods or estimating the demands to be lower than those acquired by using the other prediction methods is included. In other words, the demand prediction generating unit 112 calculates a plurality of predicted demands Dₚ by using a plurality of prediction methods, whereby there is a width in the predicted demands Dₚ.

The prediction model generating unit 113 is a processor that generates a basic model used for calculating a stock quantity for each period. The prediction model generating unit 113 generates a basic model M₁ represented in the following Equations (1) and (2). Here, a predicted stock quantity of products present in the warehouse at the start of the (k+1)-th period is denoted as yₚ[k+1], a stock quantity that is actually present in the warehouse at the start of the k-th period is denoted as yᵣ[k], an order quantity of the k-th period is u[k], a predicted demand of the k-th period is denoted as Dₚ[k], and a maximum stock quantity that is held for the k-th period is denoted as St.

M₁: yₚ[k+1]=yᵣ[k]+u[k]−Dₚ[k] (1)

St=y[k]+u[k] (2)

In addition, the prediction model generating unit 113 may reflect a lead time, which is a time until a product arrives at the warehouse after the product is ordered, on the basic model. The prediction model generating unit 113 acquires the lead time from the setting information table 142. The prediction model generating unit 113 generates a basic model M₂ represented in the following Equation (3) based on the acquired lead time. In Equation (3), a lead time is denoted as Lt, and an order interval is denoted as h. In addition, a maximal stock quantity St is represented in Equation (2).

M₂: yₚ[k+1]=yᵣ[k]+u[k−floor(Lt/h)]−Dₚ[k] (3)

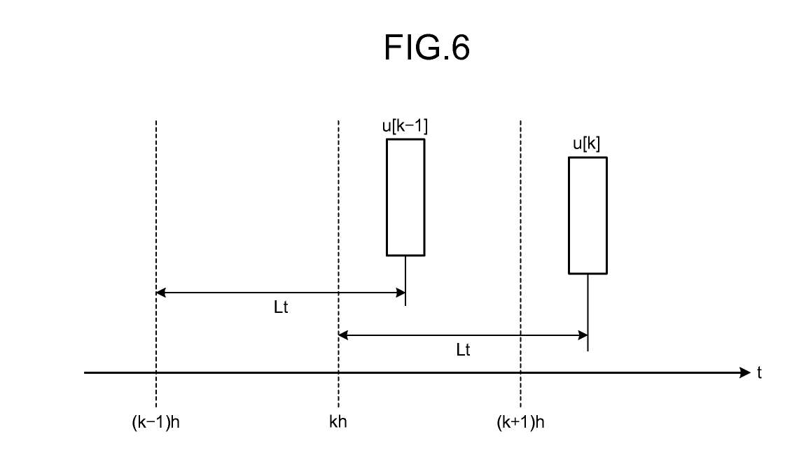

FIG. 6 is a diagram that illustrates a lead time that is a time until a product arrives at a warehouse after the product is ordered. As illustrated in the example represented in FIG. 6, after a product is ordered, the product arrives at the warehouse after the lead time Lt elapses. For example, an order u[k−1] relates to a product that is ordered for the (k−1)-th period. The product ordered for the (k−1)-th period arrives at the warehouse after the k-th period. In addition, an order u[k] relates to a product that is ordered for the k-th period. The product ordered for the k-th period arrives at the warehouse after the (k+1)-th period. As above, depending on the supplier and the kind of the product, there are cases where a product ordered for a previous period arrives after the next period elapses.

In addition, the prediction model generating unit 113 may reflect the number of products to be discarded after a disposal time elapses after the order of the product to the basic model. The prediction model generating unit 113 acquires the disposal time from the setting information table 142. The prediction model generating unit 113 generates a basic model M₃ represented in the following Equation (4) based on the acquired disposal time. In Equation (4), the disposal time is Wt. In addition, a maximal stock quantity St is represented in Equation (2).

$${M}_{3} \text{:} if u [ k - floor ( {W}_{t} / h ) ] - y [ k - floor ( {W}_{t} / h ) ] - {\sum }_{l - k = floor ( {W}_{t} / h )}^{k} D [ 1 ] \geq 0 \\ y [ k + 1 ] = y [ k ] + u [ k ] - D [ k ] - ( u [ k - floor ( {W}_{t} / h ) ] - y [ k - floor ( {W}_{t} / h ) ] - {\sum }_{l = k - floor ( {W}_{t} / h )}^{k} D [ 1 ] ) \\ else \\ y [ k + 1 ] = y [ k ] + u [ k ] - D [ k ] \qquad ( 4 )$$

A conditional equation represented in Equation (4) will be described. In a case where a product to be discarded remains inside the warehouse for the k-th period, the optimal order quantity calculating unit 130 uses an upper-side equation represented in the basic model M₃. On the other hand, in a case where there is no product to be discarded inside the warehouse for the k-th period, the optimal order quantity calculating unit 130 uses a lower-side equation represented in the basic model M₃. In other words, the optimal order quantity calculating unit 130 determines presence/no-presence of a product to be discarded for each period and determines a basic model to be used. In addition, the process performed by the optimal order quantity calculating unit 130 will be described later in detail.

The restriction generating unit 121 is a processor that generates a restriction condition relating to an order of a product. For example, the restriction generating unit 121 generates an order quantity limit and a stock quantity limit as restriction conditions. The restriction generating unit 121 acquires each restriction condition from the setting information table 142.

The restriction generating unit 121, for example, generates a restriction equation of the following Equation (5) relating to an order quantity limit. In Equation (5), the order quantity limit is Uu.

u[k]≦Uu,u[k+1]≦Uu, . . . ,u[k+H]≦Uu (5)

The restriction generating unit 121, for example, generates a restriction equation of the following Equation (6) relating to a stock quantity limit. In Equation (6), the stock quantity limit is Us.

yₚ[k+1]+u[k+1]≦Us,yₚ[k+2]+u[k+2]≦Us, . . . ,yₚ[k+H]+u[k+H]≦Us (6)

In addition, the restriction generating unit 121 generates a restriction condition for constantly maintaining the stock quantity to be zero or more as a condition not for causing out-of-stock. The restriction generating unit 121, for example, generates a restriction equation of the following Equation (7) relating to a condition not for causing out-of-stock.

yₚ[k+1]≧0,yₚ[k+2]≧0, . . . ,yₚ[k+H]≧1 (7)

The objective function generating unit 122 is a processor that generates an objective function. Here, the objective function is a function used for calculating a profit acquired from the k-th period to the (k+H)-th period by using the predicted demand Dₚ, the stock quantity y, the order quantity u, and the like. The objective function generating unit 122 acquires the selling price, the order cost, and the storage cost of a product from the setting information table 142. Next, the objective function generating unit 122 generates an objective function O₁ of the following Equation (8). In Equation (8), the selling price of the product is denoted as m, the order cost of the product is denoted as b, and the storage cost of the product is denoted as c.

$${O}_{1} \text{:} P = {\sum }_{i = k}^{K + H} m \times {D}_{P} [ i ] - ( b \times u [ i ] + c \times y [ i + 1 ] ) \qquad ( 8 )$$

In addition, in a case where the order cost is different depending on the order quantity of a product, the objective function generating unit 122 may classify cases using a conditional equation and define order costs according to order quantities. For example, there are cases where an order cost per product is lower in a case where products are purchased in units of sets than in a case where the products are individually purchased. The objective function generating unit 122 acquires an order cost per one set and an order cost per product from the setting information table 142. Then, the objective function generating unit 122 generates an objective function O₂ of the following Equation (9). In Equation (9), an order cost per one set that is configured by R products is denoted as b₁, and an order cost per product is denoted as b₂. In addition, the selling price of the product is denoted as m, and the storage cost of the product is c.

$${O}_{2} \text{:} P = {\sum }_{i = k}^{K + H} m \times {D}_{P} [ i ] - \{ {b}_{1} \times floor ( u [ i ] / R ) + {b}_{2} \times ( u [ i ] - R \times floor ( u [ i ] / R ) ) + c \times y [ i + 1 ] \} \qquad ( 9 )$$

Furthermore, the objective function generating unit 122 may reflect a disposal cost occurring at the time of discarding a product on the objective function. The objective function generating unit 122 acquires a disposal cost and a disposal time from the setting information table 142. Then, the objective function generating unit 122 generates an objective function O₃ of the following Equation (10). In Equation (10), the selling price of the product is denoted as m, the order cost of the product is denoted as b, the storage cost of the product is denoted as c, the disposal cost of the product is denoted as d, and the disposal time of the product is denoted as Wt.

$${O}_{3} \text{:} P = {\sum }_{i = k}^{K + H} m \times {D}_{P} [ i ] - ( b \times u [ i ] + c \times {y}_{P} [ i + 1 ] ) - d \times ( u [ i - floor ( {W}_{t} / h ) ] - y [ i - floor ( {W}_{t} / h ) ] - {\sum }_{1 = k - floor ( {W}_{t} / h )}^{k} D [ 1 ] ) \qquad ( 10 )$$

The optimal order quantity calculating unit 130 is a processor that calculates an optimal order quantity for which a profit within a designated period is the highest in a range satisfying a restriction condition. The optimal order quantity calculating unit 130 solves an optimization problem using a plurality of demand predictions based on the basic model, the restriction condition, and the objective function, thereby acquiring optimal order quantities u[k] to u[k+H] of the designated period of the k-th period to the (k+H)-th period.

For example, the optimal order quantity calculating unit 130 solves the optimization problem such that a minimal value of the profit is the highest, thereby acquiring optimal order quantities u[k+j] (j=1, . . . , H) of the periods. For example, the optimal order quantity calculating unit 130 solves the optimization problem by using the following Equations (11) and (12). Equation (11) is a numerical equation used for calculating order quantities of a case where the minimal value of the profit is the highest. In Equation (11), Pᵢ is a profit calculated by applying the predicted demands Dᵣ[k] to Dᵣ[k+H] acquired by using the prediction methods pᵢ (here, i=1, . . . , N) of the demand to an objective function. In addition, Equation (12) is a restriction equation that is generated by the restriction generating unit 121. The optimal order quantity calculating unit 130 sets the order quantities u[k] to u[k+H] in a range satisfying the condition equation of Equation (12) such that minPᵢ that is the minimum of P₁ to P_{N} is the highest.

$$\begin{matrix}{max}_{u [ k ] , … u [ k + H ]} {min}_{pi} {P}_{i} ( i = 1 , … , N ) & ( 11 ) \\ {y}_{pi} [ k + j ] \geq 0 , \\ u [ k + j ] < Uu , \\ {St}_{pi} [ k + j ] < Us ( here , j = 1 , … , H ) & ( 12 )\end{matrix}$$

Next, the optimal order quantity calculating unit 130 calculates a range of the profit considered based on the set order quantity of each period. For example, the optimal order quantity calculating unit 130 calculates predicted profits P₁ to P_{N} corresponding to the prediction methods p₁ to p_{N} by using the set order quantities u[k] to u[k+H] of each period. Next, the optimal order quantity calculating unit 130 acquires a maximal value and a minimal value of predicted profits among the calculated predicted profits P₁ to P_{N} and acquires the range of the profit prediction. In other words, the optimal order quantity calculating unit 130 sets a maximal value of the predicted profit as an upper limit of the range of the profit prediction and sets a minimal value of the predicted profit as a lower end of the range of the profit prediction.

Output Unit

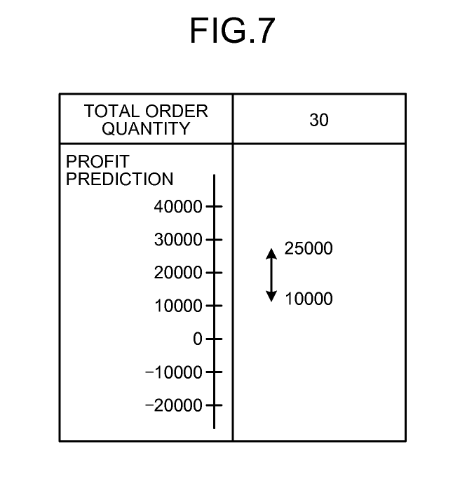

The output unit 160 is a processor that outputs a GUI image representing a total order quantity and the range of the profit prediction in a table form to an output device such as a monitor. The output unit 160 outputs a GUI image illustrated in FIG. 7 to a monitor 20. FIG. 7 is a diagram that illustrates a first example of the GUI image. As illustrated in the example represented in FIG. 7, the output unit 160 outputs the GUI image representing that a maximal value of the profit prediction for a total order quantity of 30 is 25,000 and a minimum value thereof is 10,000 to the monitor 20.

Flow of Process

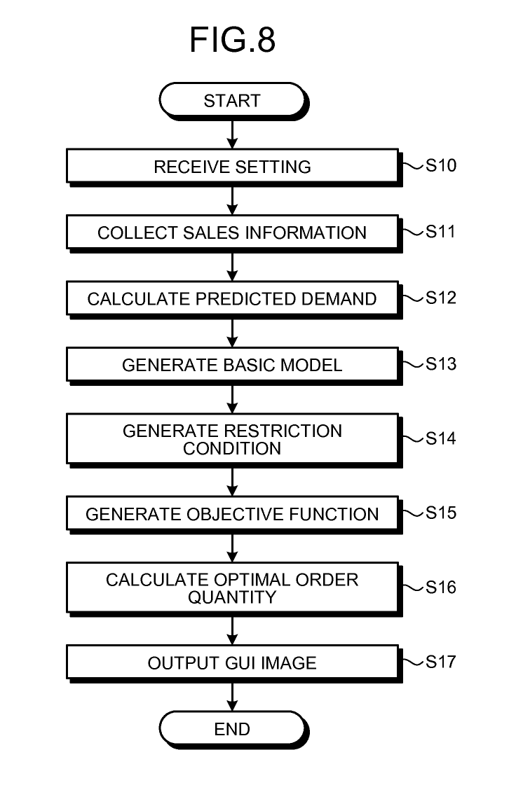

Next, a process of acquiring optimal order quantities will be described with reference to FIG. 8. FIG. 8 is a flowchart that illustrates an example of the flow of the entire process of acquiring optimal order quantities. As illustrated in the example represented in FIG. 8, the input unit 150 receives inputs of various settings such as a selling price, a lead time, an order cost, a storage cost, a disposal cost, an order quantity limit, a stock quantity limit, a prediction section, and a disposal time of a product from the user terminal 10 in Step S10. The data collecting unit 111 collects sales information acquired from the sales data 141 for each period in Step S11, thereby calculating an actual demand Dᵣ[k−1] of the product.

The demand prediction generating unit 112 calculates predicted demands Dₚᵢ[k] to Dₚᵢ[k+H] (here, i=1, . . . , N) using the past demands Dᵣ[1] to Dᵣ[k−1] by using N prediction methods p₁ to p_{N} of the demand in Step S12.

The prediction model generating unit 113 generates a basic model used for calculating a stock quantity of each period in Step S13. The basic model includes an equation corresponding to the predicted stock quantity yₚ at the start of each period and an equation corresponding to a predicted maximum stock quantity St of each period. The equation corresponding to the predicted stock quantity yₚ of products present in the warehouse at the start of each period, for example, is Equation (1), (3), or (4). In addition, the equation corresponding to the predicted maximum stock quantity St of each period, for example, is Equation (2).

The restriction generating unit 121 generates restriction conditions corresponding to the order quantity limit and the stock quantity limit and a restriction condition for constantly maintaining the stock quantity to be zero or more as a condition not causing out-of-stock in Step S14. The restriction condition corresponding to the order quantity limit, for example, is Equation (5). In addition, the restriction condition corresponding to the stock quantity limit, for example, is Equation (6). The restriction condition used for not causing out-of-stock, for example, is Equation (7).

The objective function generating unit 122 generates an objective function used for calculating a profit within designated periods k to k+H in Step S15. The objective function, for example, is Equation (8), (9), or (10).

The optimal order quantity calculating unit 130 solves the optimization problem based on the basic model, the restriction conditions, and the objective function and calculates optimal order quantities for which the profits within the designated periods k to k+H are highest in Step S16. For example, the optimal order quantity calculating unit 130 solves the optimization problem by using Equations (11) and (12) such that a profit that can be secured at the least is the highest, thereby acquiring each optimal order quantity u[j] (j=k, . . . , K+H) of each period. The optimal order quantity calculating unit 130 acquires a range of the profit prediction based on the optimal order quantity u[j] of each period.

The output unit 160 outputs a GUI image including a total order quantity and display of the range of the profit prediction to the monitor 20 in Step S17. At this time, the displayed GUI image, for example, is illustrated in FIG. 7.

In this way, the order quantity determining apparatus 100 can acquire an order quantity for which a secured profit is highest while suppressing out-of-stock by minimally suppressing a loss according to the storage cost of the product and the disposal cost of the product.

Advantage Toward Prediction Uncertainty

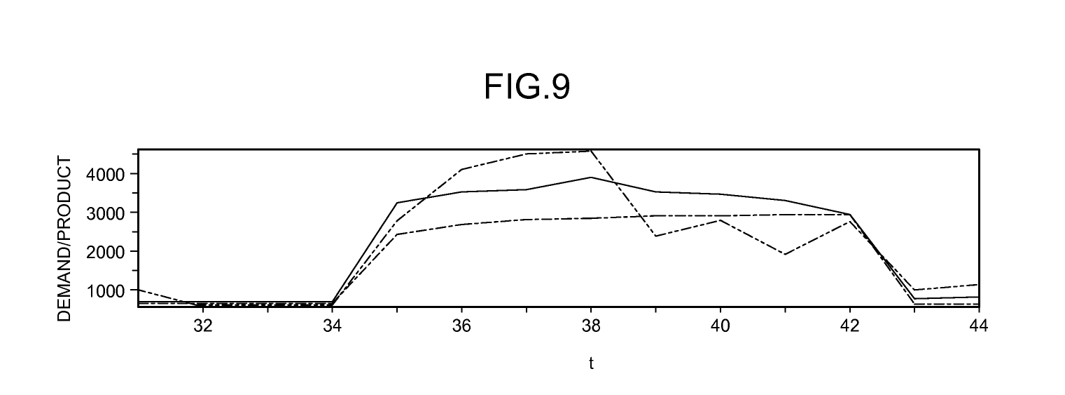

Next, an example of an advantage toward prediction uncertainty will be described with reference to FIGS. 9 to 11. FIG. 9 is a diagram that illustrates a first example of predicted demands. In FIG. 9, the vertical axis represents the predicted demand in units of products, and the horizontal axis represents the period. A solid line represents a predicted demand according to the prediction method p₁. A chain line represents a predicted demand according to the prediction method p₂. A two-dot chain line represents a predicted demand according to the prediction method p₃. As illustrated in the example represented in FIG. 9, there are differences between demands predicted according to the prediction methods for the 34th period to the 42nd period.

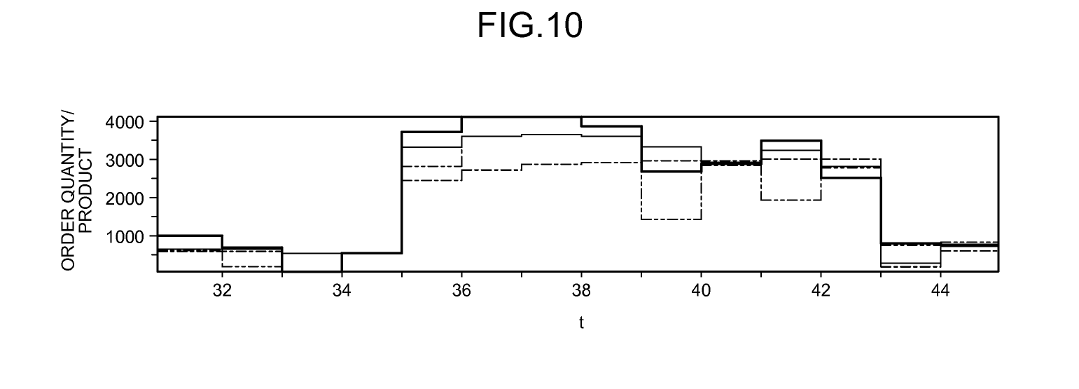

FIG. 10 is a diagram that illustrates a first example of an optimal order quantity. In FIG. 10, the vertical axis represents the order quantity in units of products, and the horizontal axis represents the period. A solid line represents an optimal order quantity that is calculated based on the predicted demand according to the prediction method p₁. A chain line represents an optimal order quantity that is calculated based on a predicted demand according to the prediction method p₂. A two-dot chain line represents an optimal order quantity that is calculated based on a predicted demand according to the prediction method p₃.

A thick line represents a trend of the optimal order quantity determined by the order quantity determining apparatus 100 such that a minimal value of the profit is the highest. The optimal order quantity calculating unit 130 calculates optimal order quantities u[k] to u[k+H] for which a minimal value of the predicted profit is maximal by using the predicted demands corresponding to the prediction methods p₁, p₂, and p₃ represented in FIG. 9.

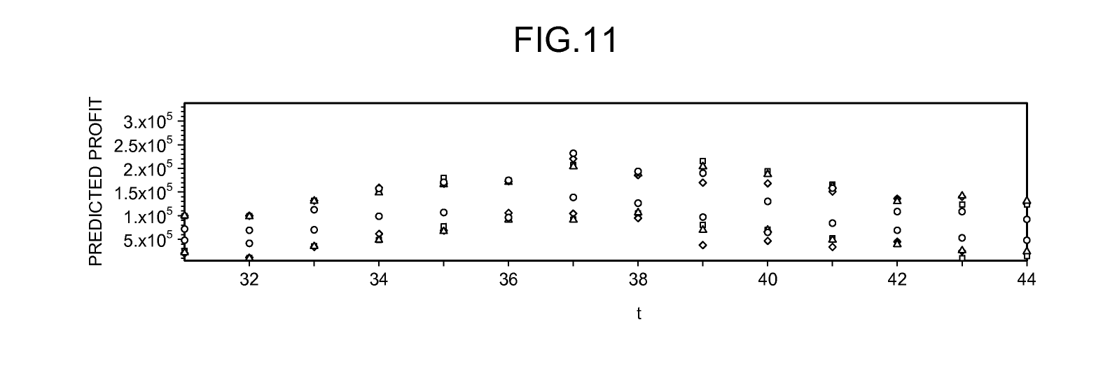

FIG. 11 is a diagram that illustrates a first example of the predicted profit. In FIG. 11, the vertical axis represents the predicted profit, and the horizontal axis represents the period. As illustrated in the example represented in FIG. 11, a maximal value and a minimal value of the predicted profit of each period are calculated by using the predicted demands predicted using the prediction methods p₁, p₂, and p₃. In FIG. 11, “Δ” represents a maximal value and a minimal value of the predicted profit corresponding to the prediction method p₁. “□” represents a maximal value and a minimal value of the predicted profit corresponding to the prediction method p₂. In addition, “⋄” represents a maximal value and a minimal value of the predicted profit corresponding to the prediction method p₃. “O” represents a maximal value and a minimal value of the predicted profit calculated based on the optimal order quantities u[k] to u[k+H]. The optimal order quantity calculating unit 130 acquires the range of the profit prediction by collecting the maximal value and the minimal value of the predicted profit corresponding to “O”.

In this way, the order quantity determining apparatus 100 determines an optimal order quantity by using a plurality of demand predictions. Accordingly, also in a case where a variation in the demand is irregular, and it is difficult to make a demand prediction, an optimal order quantity for which out-of-stock and an increase in the storage cost are suppressed to be minimal can be acquired.

Advantage of Prediction

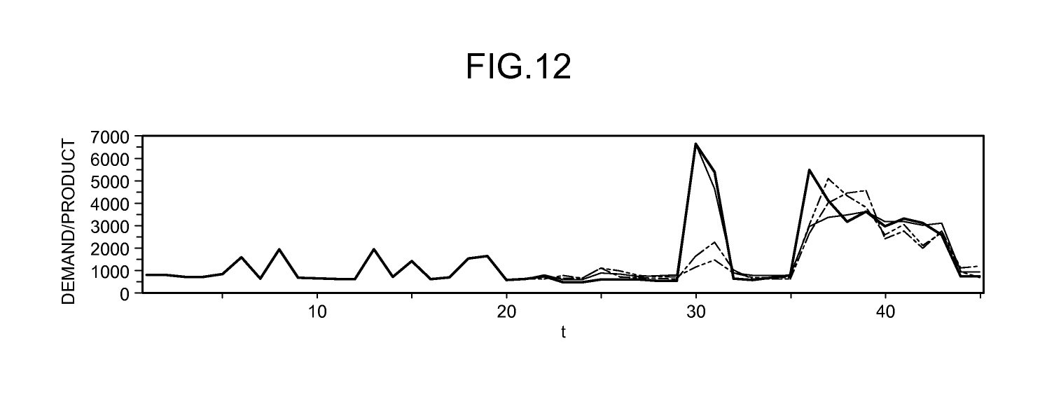

Next, an example of the advantage of the prediction will be described with reference to FIGS. 12 to 14. FIG. 12 is a diagram that illustrates a second example of the predicted demand. In FIG. 12, the vertical axis represents the predicted demand in units of products, and the horizontal axis represents the period. A solid line represents a predicted demand according to the prediction method p₁. A chain line represents a predicted demand according to the prediction method p₂. A two-dot chain line represents a predicted demand according to the prediction method p₃. A thick line represents an actual demand. As illustrated in the example represented in FIG. 12, demands are predicted over the zero-th period to the 45th period, and, particularly, actual demands increase between the 29th period to the 32nd period. In addition, between the 29th period to the 32nd period, the demand according to the prediction method p₁ coincides with the actual demand on the whole, and demands according to the prediction methods p₂ and p₃ are smaller than actual demands.

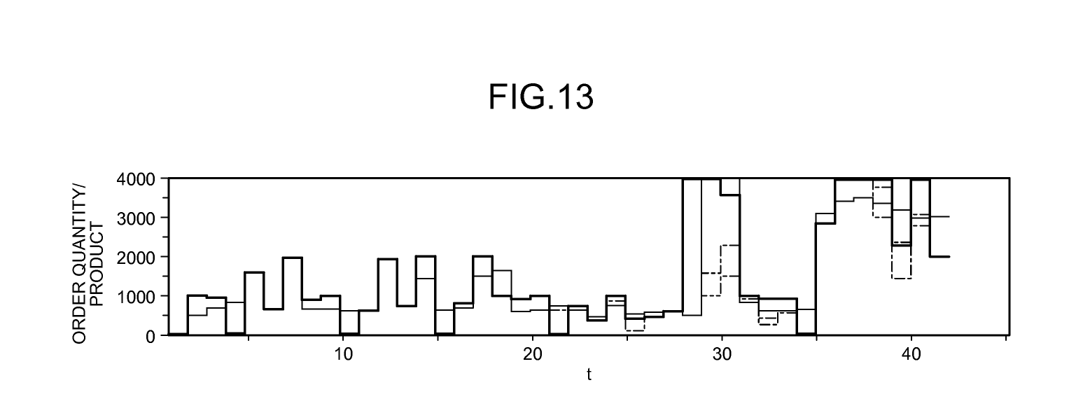

FIG. 13 is a diagram that illustrates a second example of the optimal order quantity. In FIG. 13, the vertical axis represents the order quantity in units of products, and the horizontal axis represents the period. A solid line represents a predicted order quantity, which is calculated based on the predicted demand according to the prediction method p₁, according to a related technology. A chain line represents a predicted order quantity, which is calculated based on the predicted demand according to the prediction method p₂, according to the related technology. A two-dot chain line represents a predicted order quantity, which is calculated based on the predicted demand according to the prediction method p₃, according to the related technology.

A thick line represents a trend of the optimal order quantity determined by the order quantity determining apparatus 100 such that a minimal value of the profit is the highest. Since the order quantity limit of one period is 4,000, even when the order quantity determining apparatus 100 starts to increase the order quantity at the 29th period at which the demand starts to increase, there are cases where the supply of products is out of time, and out-of-stock occurs. Thus, as illustrated in the example represented in FIG. 13, the order quantity determining apparatus 100 increases the order quantity of the 28th period in preparation for the 29th period at which the demand starts to increase. In this way, out-of-stock can be avoided.

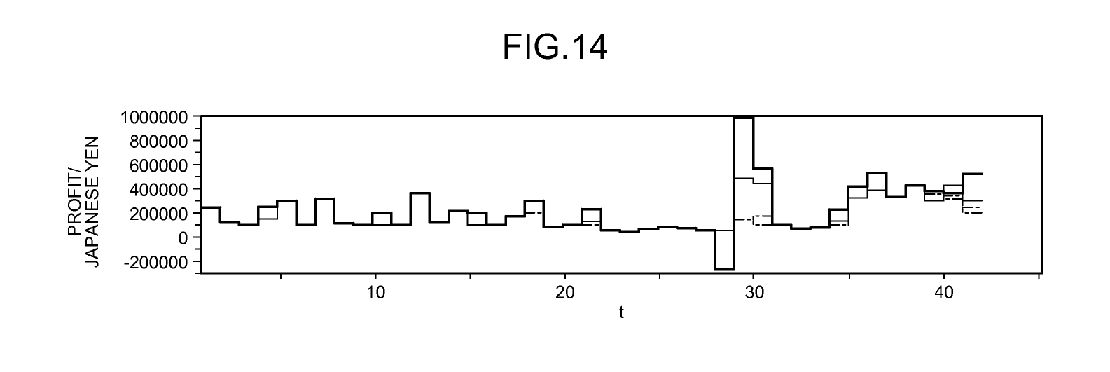

FIG. 14 is a diagram that illustrates a second example of the predicted profit. In FIG. 14, the vertical axis represents the profit, and the horizontal axis represents the period. A solid line represents a profit that is based on the prediction method p₁. A chain line represents a profit that is based on the prediction method P₂. A two-dot chain line represents a profit that is based on the prediction method p₃. A thick line represents a profit that is based on the optimal order quantity. As illustrated in the example represented in FIG. 14, since out-of-stock can be avoided, the profit that is based on the optimal order quantity of the 29th period to the 31th period increases.

In this way, the order quantity determining apparatus 100 advances a period at which the order quantity increases in preparation for an abrupt increase in the demand by enlarging a prediction section of the order quantity, and accordingly, out-of-stock is avoided, and the profit can be maximally secured.

In addition, by enlarging the prediction section of the order quantity, the order quantity determining apparatus 100 can also suppress an order quantity from a period earlier than a period at which a decrease in the demand is predicted in preparation for the decrease in the demand.

### Advantage of First Embodiment

As described above, the order quantity determining apparatus 100 receives the restriction information that is used for calculating a profit based on the order quantity of the product. The order quantity determining apparatus 100 searches for order quantities of the k-th period to the (k+H)-th period for which the profit is the highest by using the restriction information. The order quantity determining apparatus 100 outputs the order quantity of the k-th period among the retrieved order quantities. In this way, order quantities for which the profit is predicted to be the highest under the restriction can be determined.

The order quantity determining apparatus 100 receives one or more of the order cost, the storage cost, and the date of delivery. The order quantity determining apparatus 100 solves the optimization problem having profits of the k-th period to the (k+H)-th period as an objective function in consideration of one or more of the order cost, the storage cost, and the date of delivery, thereby acquiring an order quantity of the k-th period. In this way, the order quantity can be set in consideration of various costs and the date of delivery, and accordingly, the profit can be further raised.

The order quantity determining apparatus 100 predicts demands of the k-th period to the (k+H)-th period and solves the optimization problem having a profit of the k-th period to the (k+H)-th period as an objective function in consideration of the predicted demands, thereby acquiring an order quantity of the k-th period. In this way, by solving the optimization problem by using the objective function, an optimal order quantity having high accuracy can be acquired.

The order quantity determining apparatus 100 solves the optimization problem having profits of the k-th period to the (k+H)-th period as an objective function in consideration of actual demands, thereby acquiring an order quantity of the k-th period. In this way, by considering the actual demands, the accuracy of the predicted demand can be improved, and accordingly, an optimal order quantity having high accuracy can be acquired based on the predicted demands.

The order quantity determining apparatus 100 outputs the profit prediction together with the order quantity. In this way, a range of the profit predicted to be an optimal order quantity can be presented.

### [b] Second Embodiment

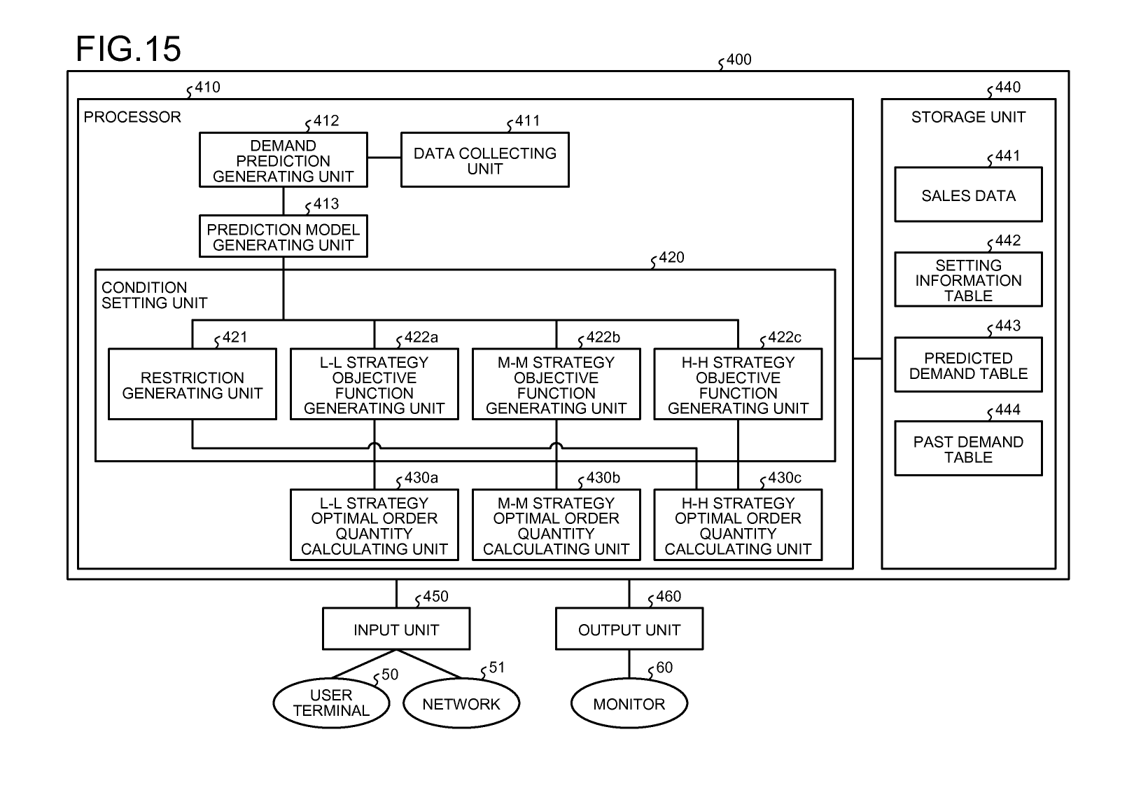

An example of the whole configuration of an order quantity determining apparatus 400 according to a second embodiment will be described. FIG. 15 is a functional block diagram that illustrates the configuration of the order quantity determining apparatus according to the second embodiment. As illustrated in the example represented in FIG. 15, the order quantity determining apparatus 400 includes a processor 410 and a storage unit 440. Here, a reference numeral having the same last two-digits is assigned to the same configuration as that of the order quantity determining apparatus 100 according to the first embodiment, and description thereof will not be presented as is appropriate.

Storage Unit

The storage unit 440 includes sales data 441, a setting information table 442, a predicted demand table 443, and a past demand table 444. The storage unit 440 corresponds to a storage device that includes a semiconductor memory device such as a RAM, a ROM, or a flash memory, a hard disk, and an optical disc.

Processor

The processor 410 includes a data collecting unit 411, a demand prediction generating unit 412, a prediction model generating unit 413, a condition setting unit 420, an L-L strategy optimal order quantity calculating unit 430a, an M-M strategy optimal order quantity calculating unit 430b, and an H-H strategy optimal order quantity calculating unit 430c. The condition setting unit 420 includes a restriction generating unit 421, an L-L strategy objective function generating unit 422a, an M-M strategy objective function generating unit 422b, and an H-H strategy objective function generating unit 422c. Here, the order quantity determining apparatus 400 is connected to an input unit 450 and an output unit 460. The input unit 450 is connected to a user terminal 50 and a network 51. The output unit 460 is connected to a monitor 60.

For example, each function of the processor 410 may be realized by a CPU executing a predetermined program. In addition, each function of the processor 410, for example, may be realized by an integrated circuit such as an ASIC or an FPGA.

The L-L strategy optimal order quantity calculating unit 430a predicts demands of the k-th period to the (k+H)-th period using a plurality of techniques for each technique. In addition, the L-L strategy optimal order quantity calculating unit 430a solves an optimization problem having a profit of the k-th period to the (k+H)-th period as an objective function such that a minimal value of the profit for each of the demands predicted using a plurality of demand predictions is maximal by using a plurality of demand predictions, thereby acquiring an order quantity of the k-th period so as to increase the profit.

In addition, the M-M strategy optimal order quantity calculating unit 430b predicts demands of the k-th period to the (k+H)-th period using a plurality of techniques for each technique. In addition, the M-M strategy optimal order quantity calculating unit 430b solves an optimization problem having a profit of the k-th period to the (k+H)-th period as an objective function such that an average value for each of the demands predicted using the plurality of techniques is maximal, thereby acquiring an order quantity of the k-th period so as to increase the profit.

Furthermore, the H-H strategy optimal order quantity calculating unit 430c predicts demands of the k-th period to the (k+H)-th period using a plurality of techniques for each technique. In addition, the H-H strategy optimal order quantity calculating unit 430c solves an optimization problem having a profit of the k-th period to the (k+H)-th period as an objective function such that a maximal value of profits for each of the demands predicted using the plurality of demand predictions is maximal, thereby acquiring an order quantity of the k-th period so as to increase the profit. Hereinafter, each configuration of the processor 410 will be described in detail.

The condition setting unit 420 according to the second embodiment includes the L-L (Low risk-Low return) strategy objective function generating unit 422a, the M-M (Middle risk-Middle return) strategy objective function generating unit 422b, and the H-H (High risk-High return) strategy objective function generating unit 422c. The condition setting unit 420 includes three objective function generating units, which is different from the condition setting unit 120 according to the first embodiment. In addition, the processor 410 includes the L-L strategy optimal order quantity calculating unit 430a, the M-M strategy optimal order quantity calculating unit 430b, and the H-H strategy optimal order quantity calculating unit 430c. The processor 410 includes three strategy optimal order quantity calculating units, which is different from the processor 110 according to the first embodiment.

The order quantity determining apparatus 400 calculates a profit range that is predicted to be an optimal order quantity for each of an L-L strategy, an M-M strategy, an H-H strategy, and the like and displays a result thereof on the monitor 60. Hereinafter, the process of each strategy will be individually described.

A process corresponding to the L-L strategy will be described. The L-L strategy objective function generating unit 422a is a processor that generates an objective function used for calculating an order quantity for which a minimal value of the profit is the highest within a designated period. For example, the L-L strategy objective function generating unit 422a generates an equation corresponding to Equation (8), (9), or (10) and an equation corresponding to Equation (11). In Equation (11), minPᵢ (here, i=1, . . . , N) is a lowest predicted profit of the predicted profits P₁ to P_{N}. The L-L strategy objective function generating unit 422a outputs each equation that has been generated to the L-L strategy optimal order quantity calculating unit 430a.

The L-L strategy optimal order quantity calculating unit 430a is a processor that calculates an order quantity for which a minimal value of the profit is the highest within the designated period. The L-L strategy optimal order quantity calculating unit 430a solves an optimization problem by using Equations (11) and (12), thereby acquiring optimal order quantities u[k] to u[k+H]. Next, the L-L strategy optimal order quantity calculating unit 430a calculates predicted profits P₁ to P_{N} corresponding to the prediction methods p₁ to p_{N} by using the optimal order quantities u[k] to u[k+H]. Next, the L-L strategy optimal order quantity calculating unit 430a selects a maximal value and a minimal value of the calculated predicted profits P₁ to P_{N} and acquires a range of the profit prediction. For example, the L-L strategy optimal order quantity calculating unit 430a calculates the minimal value of the range of the profit prediction by using Equation (13). In addition, the L-L strategy optimal order quantity calculating unit 430a calculates the maximal value of the range of the profit prediction by using Equation (14). Then, the L-L strategy optimal order quantity calculating unit 430a outputs a total order quantity and the range of the profit prediction to the output unit 460. Here, the total order quantity is a total value of optimal order quantities of the periods.

$$\begin{matrix}{P}_{min}^{L} = {min}_{i = 1 … N} \{ {P}_{i}^{L} \} & ( 13 ) \\ {P}_{max}^{L} = {max}_{i = 1 … N} \{ {P}_{i}^{L} \} & ( 14 )\end{matrix}$$

Next, a process corresponding to the M-M strategy will be described. The M-M strategy objective function generating unit 422b is a processor that generates an objective function used for calculating an order quantity for which an average value of the predicted profits P₁ to P_{N} is the highest. For example, the M-M strategy objective function generating unit 422b generates an equation corresponding to Equation (8), (9), or (10) and an equation corresponding to Equation (15) represented below. In Equation (15), Eₚᵢ [Pᵢ](here, i=1, . . . , N) is an average value of the predicted profits P₁ to P_{N}. The M-M strategy objective function generating unit 422b outputs each equation that has been generated to the M-M strategy optimal order quantity calculating unit 430b.

$${max}_{u [ k ] , … u [ k + H ]} {E}_{pi} [ {P}_{i} ] ( i = 1 , … , N ) \qquad ( 15 )$$

The M-M strategy optimal order quantity calculating unit 430b is a processor that calculates an order quantity for which an average value of the predicted profits P₁ to P_{N} is the highest. The M-M strategy optimal order quantity calculating unit 430b solves an optimization problem using Equations (12) and (15), thereby acquiring optimal order quantities u[k] to u[k+H]. Next, the M-M strategy optimal order quantity calculating unit 430b, similar to the L-L strategy optimal order quantity calculating unit 430a, calculates predicted profits P₁ to P_{N} based on the optimal order quantities u[k] to u[k+H] and acquires a range of the profit predictions. For example, the M-M strategy optimal order quantity calculating unit 430b calculates a minimal value of the range of the profit prediction by using Equation (16). In addition, the M-M strategy optimal order quantity calculating unit 430b calculates a maximal value of the range of the profit prediction by using Equation (17). Then, the M-M strategy optimal order quantity calculating unit 430b outputs a total order quantity and the range of the profit prediction to the output unit 460.

$$\begin{matrix}{P}_{min}^{M} = {min}_{i = 1 … N} \{ {P}_{i}^{M} \} & ( 16 ) \\ {P}_{max}^{M} = {max}_{i = 1 … N} \{ {P}_{i}^{M} \} & ( 17 )\end{matrix}$$

Next, a process corresponding to the H-H strategy will be described. The H-H strategy objective function generating unit 422c is a processor that generates an objective function used for calculating an order quantity for which a maximal value of the predicted profit is the highest within a designated period. For example, the H-H strategy objective function generating unit 422c generates an equation corresponding to Equation (8), (9), or (10) and an equation corresponding to Equation (18). In Equation (18), maxPᵢ (here, i=1, . . . , N) is a highest predicted profit of the predicted profits P₁ to P_{N}. The H-H strategy objective function generating unit 422c outputs each equation that has been generated to the H-H strategy optimal order quantity calculating unit 430c.

$${max}_{u [ k ] , … u [ k + H ]} max {P}_{i} {( i = 1 , … , N )}_{pi} \qquad ( 18 )$$

The H-H strategy optimal order quantity calculating unit 430c is a processor that calculates an order quantity for which a maximal value of the predicted profits P₁ to P_{N} is the highest. The H-H strategy optimal order quantity calculating unit 430c solves an optimization problem by using Equations (12) and (18), thereby acquiring optimal order quantities u[k] to u[k+H]. Next, the H-H strategy optimal order quantity calculating unit 430c, similar to the L-L strategy optimal order quantity calculating unit 430a, calculates predicted profits P₁ to P_{N} based on the optimal order quantities u[k] to u[k+H] and acquires a range of the profit prediction. For example, the H-H strategy optimal order quantity calculating unit 430c calculates a minimal value of the range of the profit prediction by using Equation (19). In addition, the H-H strategy optimal order quantity calculating unit 430c calculates a maximal value of the range of the profit prediction by using Equation (20). Then, the H-H strategy optimal order quantity calculating unit 430c outputs a total order quantity and the range of the profit prediction to the output unit 460.

$$\begin{matrix}{P}_{min}^{H} = {min}_{i = 1 … N} \{ {P}_{i}^{H} \} & ( 19 ) \\ {P}_{max}^{H} = {max}_{i = 1 … N} \{ {P}_{i}^{H} \} & ( 20 )\end{matrix}$$

Output Unit

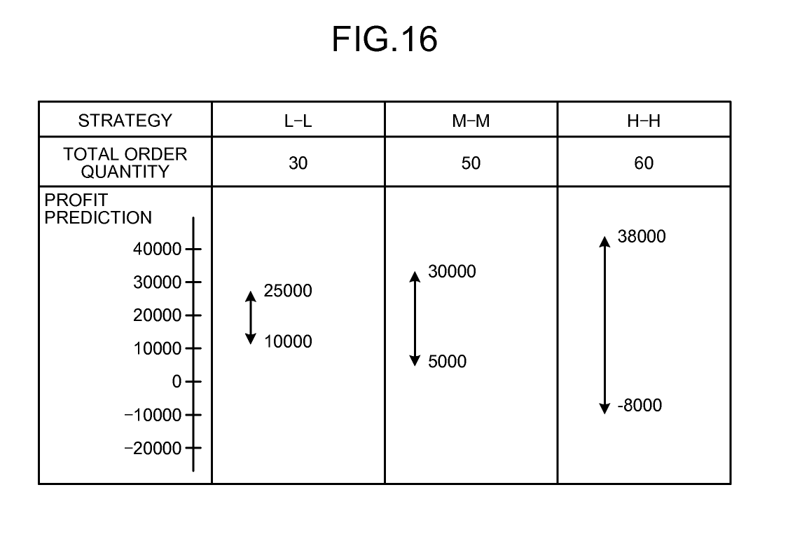

The output unit 460 is a processor that outputs a GUI image representing a total order quantity and the range of the profit prediction corresponding to each strategies in a table form to an output device such as a monitor. The output unit 460 generates the GUI image based on the total order quantity and the range of the profit prediction of each strategy and outputs the generated GUI image to the monitor 60. FIG. 16 is a diagram that illustrates a second example of the GUI image. As illustrated in the example represented in FIG. 16, in a case where the L-L strategy is employed, the GUI image represents that a total order quantity is 30, a maximal value of the profit prediction is 25,000, and a minimum value thereof is 10,000. On the other hand, in a case where the M-M strategy is employed, the GUI image represents that a total order quantity is 50, a maximal value of the profit prediction is 30,000, and a minimum value thereof is 5,000. In addition, in a case where the H-H strategy is employed, the GUI image represents that a total order quantity is 60, a maximal value of the profit prediction is 38,000, and a minimum value thereof is −8,000. The output unit 460, by displaying the ranges of the profit predictions corresponding to the strategies using arrows in a parallel manner, can display a profit and a risk of a case where each strategy is employed in an easily-comparable manner.

As described above, the order quantity determining apparatus 400 calculates the optimal order quantity and the profit range for each of strategies such as the L-L strategy, the M-M strategy, and the H-H strategy and accordingly, is capable of supporting a determination of the order quantity corresponding to a strategy of a company such as a strategy stressing risk avoidance or a strategy stressing maximization of the profit.

### Advantage of Second Embodiment

As described above, the order quantity determining apparatus 400 predicts demands of the k-th period to the (k+H)-th period by using a plurality of techniques for each technique. The order quantity determining apparatus 400 solves the optimization problem having the profit of the k-th period to the (k+H)-th period as an objective function such that a profit that can be secured to the minimum increases, thereby acquiring an order quantity of the k-th period so as to increase the profit. In this way, an order quantity for which the minimal value of the profit is the highest can be calculated.

The order quantity determining apparatus 400 predicts the demands of the k-th period to the (k+H)-th period by using a plurality of techniques for each technique and acquires profits for the demands predicted using the plurality of techniques. The order quantity determining apparatus 400 solves an optimization problem having a profit of the k-th period to the (k+H)-th period as an objective function such that an average value of the acquired profits increases, thereby acquiring an order quantity of the k-th period so as to increase the profit. In this way, an order quantity for increasing the profit in a case where a risk of an intermediate level is taken can be calculated.

The order quantity determining apparatus 400 predicts the demands of the k-th period to the (k+H)-th period by using a plurality of techniques for each technique and acquires an order quantity of the k-th period so as to increase the profit by solving an optimization problem having a profit of the k-th period to the (k+H)-th period as an objective function such that a maximal value of the predicted profit increases. In this way, an order quantity for which the maximal value of the profit is a maximum can be calculated.

### Other Embodiments Relating to First and Second Embodiments

In the first embodiment described above, while the demand prediction generating unit 112 calculates the predicted demands Dₚᵢ[k] to Dₚᵢ[k+H] of the k-th period to the (k+H)-th period by using the past demands Dᵣ[1] to Dᵣ[k−1], the present invention is not limited thereto. The demand prediction generating unit 112, in a case where an actual demand Dᵣ after the k-th period is acquired, may reflect the actual demand Dᵣ after the k-th period on the predicted demand Dₚᵢ. For example, the demand prediction generating unit 112 or 412, in a case where the demand Dᵣ[k] of the k-th period is acquired, may calculate the predicted demands Dₚᵢ[k+1] to Dₚᵢ[k+H] of the (k+1)-th period to the (k+H)-th period.

While the order quantity determining apparatus 400 according to the second embodiment calculates the optimal order quantity and the range of the profit prediction for each of the L-L strategy, the M-M strategy, and the H-H strategy, the present invention is not limited thereto. For example, the order quantity determining apparatus 400 may calculate an optimal order quantity and a profit range for which a profit that is the i-th profit (here, i=1, . . . , N) in order of the highest to lowest profit among the calculated predicted profits P₁ to P_{N} is the highest.

In a case where the actual demand of the k-th period is higher than the predicted demand, and out-of-stock occurs, the order quantity determining apparatus 100 according to the first embodiment or the order quantity determining apparatus 400 according to the second embodiment may increase the optimal order quantities u[k+1] to u[k+H] after the (k+1)-th period.

In the first embodiment, while the restriction generating unit 121 generates the restriction condition of Equation (7) for constantly maintaining the stock quantity to be zero or more, the present invention is not limited thereto. For example, the restriction generating unit 121 may set a predetermined amount of margin a in the stock quantity and generate a restriction condition for constantly maintaining the stock quantity to be a or more.

In the first embodiment described above, while the sales data 141 stores the sales information in units of dates, the present invention is not limited thereto. For example, the sales data 141 may store the sales information in units of weeks, in units of months, in units of half days, or in units of hours as periods.

In the first embodiment described above, the length of the prediction section H that is input from the user terminal 10 may be changed according to the property of the product. For example, in case of a fresh food, the prediction section H may be set to be short.

While the optimal order quantity calculating unit 130 according to the first embodiment described above calculates the optimal order quantity by solving the optimization problem by using the plurality of demand predictions, the present invention is not limited thereto. For example, the optimal order quantity calculating unit 130 may solve the optimization problem by using one demand prediction.

In the first embodiment described above, the selling price of the setting ID of “2” that is stored in the setting information table 142 may be configured to change depending on a period. The setting information table 142, for example, may store initial selling price in the first setting, store selling price after change in the second setting, and store a period from which the change occurs in the condition value.

In addition, the processing sequences, the control sequences, specific names, and information including various kinds of data and parameters illustrated in the first and second embodiments may be arbitrarily changed unless otherwise mentioned.

Furthermore, the constituent elements of the order quantity determining apparatus 100 illustrated in FIG. 1 and the order quantity determining apparatus 400 illustrated in FIG. 15 are functional/conceptual elements and are not limited to be physically configured as illustrated in the figures. In other words, the specific embodiment of separation/integration of the order quantity determining apparatus 100 is not limited to that illustrated in the figure, and all or some thereof may be configured to be separated or integrated functionally or physically in an arbitrary unit according to various loads, use statuses, and the like.

Hardware Configuration of Display Terminal

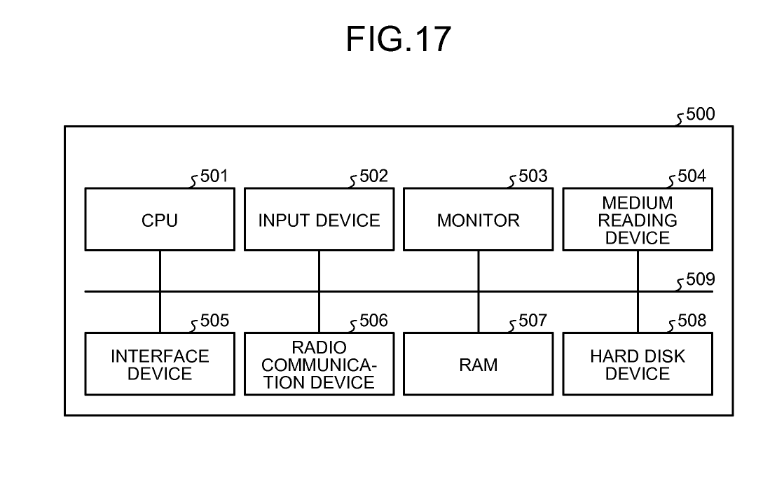

FIG. 17 is a diagram that illustrates the hardware configuration of the order quantity determining apparatus according to the first or second embodiment. As illustrated in FIG. 17, a computer 500 includes a CPU 501 that executes various arithmetic processes, an input device 502 that receives an input of data from a user, and a monitor 503. In addition, the computer 500 includes a medium reading device 504 that reads a program or the like from a recording medium, an interface device 505 that is used for a connection with the other devices, and a radio communication device 506 that is used for a wireless connection with the other devices. Furthermore, the computer 500 includes a random access memory (RAM) 507 that temporarily stores various kinds of information, and a hard disk device 508. Each of the devices 501 to 508 is connected to a bus 509.

The hard disk device 508 stores an order quantity determining program having the same functions as those of the data collecting unit 111, the demand prediction generating unit 112, the prediction model generating unit 113, the restriction generating unit 121, the objective function generating unit 122, and the optimal order quantity calculating unit 130 of the processor 110 illustrated in FIG. 1. In addition, in the hard disk device 508, various kinds of data for realizing the order quantity determining program are stored.

The CPU 501 reads each program stored in the hard disk device 508, expands the read program into the RAM 507, and executes the process, thereby executing various processes. In addition, such a program may cause the computer 500 to serve as the data collecting unit 111, the demand prediction generating unit 112, the prediction model generating unit 113, the restriction generating unit 121, the objective function generating unit 122, and the optimal order quantity calculating unit 130 of the processor 110 illustrated in FIG. 1.

In addition, the order quantity determining program is not limited to be stored in the hard disk device 508. For example, the program stored in a storage medium that is readable for the computer 500 may be read and executed by the computer 500. For example, a portable recording medium such as a CD-ROM, a DVD disc, or a universal serial bus (USB) memory, a semiconductor memory such as a flash memory, a hard disk drive, or the like corresponds to the storage medium that is readable for the computer 500. In addition, it may be configured such that this program is stored in an apparatus that is connected to a public communication line, the Internet, a local area network (LAN), or the like, and the program is read from the apparatus and is executed by the computer 500.

According to an embodiment of the present invention, there is an advantage that an order quantity for which a predicted profit is the highest under restrictions can be determined.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An order quantity determining method comprising:
receiving restriction information used for calculating a profit based on an order quantity of a product;
specifying a combination of order quantities of a k-th period to a (k+H)-th period for which the profit is the highest by using the restriction information, by a processor; and
outputting the order quantity of the k-th period based on the specified combination.

2. The order quantity determining method according to claim 1, wherein
the receiving includes receiving one or more of an order cost, a storage cost, and date of delivery, by the processor, and
the specifying includes acquiring the order quantity of the k-th period by solving an optimization problem having a profit of the k-th period to the (k+H)-th period as an objective function in consideration of one or more of the order cost, the storage cost, and the date of delivery, by the processor.

3. The order quantity determining method according to claim 1, wherein the specifying includes predicting demands of the k-th period to the (k+H)-th period and acquiring the order quantity of the k-th period by solving an optimization problem having a profit of the k-th period to the (k+H)-th period as an objective function in consideration of the predicted demands, by the processor.

4. The order quantity determining method according to claim 1, wherein the specifying includes acquiring the order quantity of the k-th period by solving an optimization problem having a profit of the k-th period to the (k+H)-th period as an objective function in consideration of actual demands, by the processor.

5. The order quantity determining method according to claim 1, wherein the specifying includes acquiring the order quantity of the k-th period by predicting demands of the k-th period to the (k+H)-th period using a plurality of techniques for each technique and solving an optimization problem having a profit of the k-th period to the (k+H)-th period as an objective function such that a profit secured to the minimum increases, by the processor.

6. The order quantity determining method according to claim 1, wherein the specifying includes acquiring the order quantity of the k-th period by predicting demands of the k-th period to the (k+H)-th period using a plurality of techniques for each technique and solving an optimization problem having a profit of the k-th period to the (k+H)-th period as an objective function such that an average value of profits for the demands that are predicted using the plurality of techniques increases, by the processor.

7. The order quantity determining method according to claim 1, wherein the specifying includes acquiring the order quantity of the k-th period by predicting demands of the k-th period to the (k+H)-th period using a plurality of techniques for each technique and solving an optimization problem having a profit of the k-th period to the (k+H)-th period as an objective function such that a maximal value of predicted profits increases, by the processor.

8. The order quantity determining method according to claim 1, wherein the outputting includes outputting a profit prediction together with the order quantity, by the processor.

9. An order quantity determining apparatus comprising a processor configured to:
receive restriction information used for calculating a profit based on an order quantity of a product;
specify a combination of order quantities of a k-th period to a (k+H)-th period for which the profit is the highest by using the restriction information; and
output the order quantity of the k-th period based on the specified combination.

10. A non-transitory computer-readable recording medium storing an order quantity determining program that causes a computer to execute a process comprising:
receiving restriction information used for calculating a profit based on an order quantity of a product;
specifying a combination of order quantities of a k-th period to a (k+H)-th period for which the profit is the highest by using the restriction information; and
outputting the order quantity of the k-th period based on the specified combination.
